(19) United States
(12) Patent Application Publication
(10) Pub. No.: US 2017/0169594 A1
(43) Pub. Date: Jun. 15, 2017

(54) METHOD AND ELECTRONIC DEVICE FOR IMPLEMENTING VIDEO RECOMMENDATION

(71) Applicants: Le Holdings (Beijing) Co., Ltd., Beijing (CN); LE SHI INTERNET INFORMATION & TECHNOLOGY CORP. BEIJING, Beijing (CN)

(72) Inventor: Fei YIN, Beijing (CN)

(21) Appl. No.: 15/250,674

(22) Filed: Aug. 29, 2016

Related U.S. Application Data
(63) Continuation of application No. PCT/CN2016/089082, filed on Jul. 7, 2016.

(30) Foreign Application Priority Data
Dec. 15, 2015 (CN) 201510939613.6

(51) Int. Cl. G06T 11/60; H04N 21/45; H04N 21/442; G06F 3/041

(52) U.S. Cl. CPC G06T 11/60; G06F 3/0416; H04N 21/4532; H04N 21/44222

(57) ABSTRACT

The embodiments of the present disclosure disclose a method and an electronic device for implementing video recommendation. The method includes: acquiring first configuration information of a primary screen of a terminal device; determining in response to a touch control instruction from a user, according to the acquired first configuration information, second configuration information of a virtual display layer interacting with the primary screen; generating the virtual display layer on the primary screen of the terminal device according to the second configuration information; and displaying video recommendation information on the virtual display layer.

### CROSS REFERENCE TO RELATED APPLICATION

This present disclosure is a continuation of International Disclosure No. PCT/CN2016/089082, filed on Jul. 7, 2016, which is based upon and claims priority to Chinese

Patent Disclosure No. 2015109396136, filed on Dec. 15, 2015, the entire contents of which are incorporated herein by reference.

### TECHNICAL FIELD

The disclosure relates to the field of communications technologies, and more particularly, to a method and an electronic device for implementing video recommendation.

### BACKGROUND

With constant development of communication technologies, video content that can be watched by users is doubled and redoubled, which greatly improves users' video application experience. However, confronted with diversified and complicated video data, the users would find it hard to rapidly catch their desired and interested video content. Therefore, to solve the above problem, a video recommendation function is developed.

Video recommendation is a method which helps the users to find their desired content in video websites such that the users can watch videos in specific fields. Compared with the traditional video directory browsing manner or video searching manner, through video recommendation, in the case where the user fails to define a suitable keyword, a specific video field desired by the user may be acquired by user behavior analysis, and video recommendation is carried out in the video field. This prevents input of the search keyword and multiple clicks of the hierarchical directories, such that searching for and watching a specific type of videos become convenient and simple.

At present, the video recommendation function may be implemented in a plurality of manners. For example, video recommendation may be carried out for the user by using the method of generating an online video tag. Specifically, the online video tag may be used to describe the characteristics of an online video, and video recommendation by using the online video tagging method has been widely applied to various video websites. The online video tag may be formed of tag content and tag strength, wherein the tag content describes the characteristics of the online video and the tag strength describes the importance of the characteristics. A terminal, by checking the tag content, is capable of identifying the characteristics of the online video, and confirming whether the online video satisfy the watching demands on the user using the terminal. The primary characteristic and the secondary characteristic of an online video may be acquired by comparing the tag strengths of all the tags of the online video. If the primary characteristic is consistent with the watching demands, it may be determined that the online video satisfies the watching demands of the user using the terminal; otherwise, although the online video satisfies the watching demands to some extent, the video may be not the optimal video matching with the watching demands.

In addition, in the related art, a history watching record of the user may be analyzed to recommend videos to the user. Specifically, according to this method, video watching record information of the user is firstly acquired, and then the user's video type demand intensity of various types of videos watched by the user may be calculated according to the video watching record information. The videos preferred by the user may be categorized according to the video type demand intensity. Finally, videos may be recommended to the user according to the video type demand intensity.

Regardless of which method is used to recommend videos to the user, a common feature of the methods lies in that video recommendation information is directly displayed on the desktop of the terminal for the user to make a selection. However, the method for directly displaying the video recommendation information on the desktop of the terminal generally occupies a large number of desktop resources of the terminal; when the video recommendation information is displayed on the desktop of the terminal, no other operation may be performed on the desktop of the terminal, which inevitably causes great inconvenience to the user.

### SUMMARY

In view of the above, the present disclosure is intended to provide a method and an electronic device for implementing video recommendation, which may prevent directly displaying video recommendation information on a desktop of a terminal, thereby releasing resources on the desktop of the terminal and improving user's operation experience.

The present disclosure provides a method for implementing video recommendation, including:

acquiring first configuration information of a primary screen of a terminal device;

determining in response to a touch control instruction from a user, according to the acquired first configuration information, second configuration information of a virtual display layer interacting with the primary screen;

generating the virtual display layer on the primary screen of the terminal device according to the second configuration information; and

displaying video recommendation information on the virtual display layer.

The present disclosure further provides an electronic device, including: at least one processor; and a memory communicably connected with the at least one processor for storing instructions executable by the at least one processor, wherein execution of the instructions by the at least one processor causes the at least one processor to: acquire first configuration information of a primary screen of a terminal device; determine in response to a touch control instruction from a user, according to the acquired first configuration information, second configuration information of a virtual display layer interacting with the primary screen; generate the virtual display layer on the primary screen of the terminal device according to the second configuration information; and display video recommendation information on the virtual display layer.

The present disclosure further provides a non-transitory computer-readable storage medium storing executable instructions that, when executed by an electronic device with a touch-sensitive display, cause the electronic device to: acquire first configuration information of a primary screen of a terminal device; determine in response to a touch control instruction from a user, according to the acquired first configuration information, second configuration information of a virtual display layer interacting with the primary screen; generate the virtual display layer on the primary screen of the terminal device according to the second configuration information; and display video recommendation information on the virtual display layer.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for implementing video recommendation according to an embodiment of the present disclosure; and

FIG. 2 is a schematic structural diagram illustrating an apparatus for implementing video recommendation in terms of functional modules according to an embodiment of the present disclosure;

FIG. 3 is a schematic structural diagram illustrating an electronic device according to the present disclosure.

### DETAILED DESCRIPTION

Nevertheless, it is not necessary to require that any technical solution of the present disclosure achieves all of the above technical effects.

To make a person skilled in the art better understand the technical solutions of the embodiments of the present disclosure, the technical solutions of the present disclosure are clearly and completely described with reference to the accompanying drawings of the embodiments of the present disclosure. Apparently, the described embodiments are only a part of the embodiments of the present disclosure, rather than the entire embodiments. Based on the embodiments of the present disclosure, all other embodiments derived by persons of ordinary skill in the art without any creative efforts shall fall within the protection scope of the present disclosure.

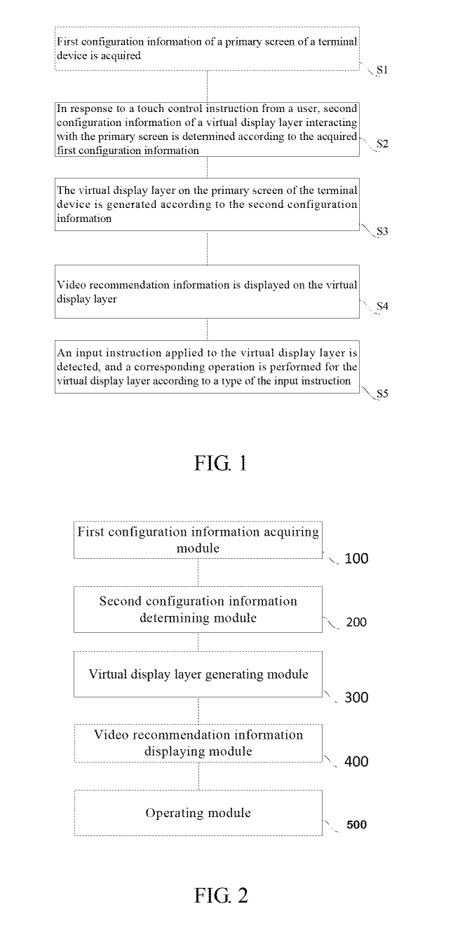

FIG. 1 is a flowchart illustrating a method for implementing video recommendation according to an embodiment of the present disclosure. Although the processes described below include multiple operations performed in a specific order, it should be clearly understood that these processes may include more or fewer operations and these operations may be executed in sequence or in parallel, for example, using parallel processors or a multi-thread environment.

As illustrated in FIG. 1, the method may include the following steps:

In step S1, first configuration information of a primary screen of a terminal device is acquired.

In the embodiment of the present disclosure, the first configuration information of the primary screen of the terminal device may be firstly analyzed. The first configuration information of the primary screen of the terminal device, for example, may include at least one of a width, a height, a pixel format, a color depth, a spacing and a memory address of the primary screen. The width, the height and the pixel format of the primary screen generally correspond to the model of the terminal device. When the terminal device is delivered from factory, the width and the height of the primary screen are determined. Using mobile phones as an example, primary screens of the mobile phones vary with the liquid crystal display (LCD) quality and research and development technology. The primary screens mainly include: thin film transistor (TFT), thin film diode (TFD), ultra fine bright (UFB), super twisted nematic (STN), and organic light-emitting diode (OLED). Generally, if more colors may be displayed, more complicated images may be displayed, and thus hierarchy of the images is richer.

The TFT is a thin film field-effect transistor and is a type of active matrix liquid crystal display. The TFT is capable of “proactively” controlling individual pixels on the screen, which greatly improves the respond speed. Generally, the reaction time of the TFT is short, about 80 ms; and the view angle is great, generally about 130 degrees. The thin film field-effect transistor refers to that each liquid crystal pixel dot on the liquid crystal display is driven by a thin film transistor integrated on the back of the liquid crystal display. In this way, screen information may be displayed at a high speed, a high luminance, and a high contrast.

The TFD screen is also referred to as a thin film diode transflective liquid crystal display The TFD technology is development by Seiko and Epson, which is dedicatedly applied in mobile phone screens. The TFD is a compromise of the TFT and the STN, which is better than the STN in luminance and color saturation and is more power-saving than the TFT. The most significant advantage of the TFD is providing high definition and visual friendly display regardless of whether backlight is disabled (reflective mode) or back light is enabled (transmissive mode). Further, the TFD also has such advantages as low power consumption, high definition, high reaction speed and the like.

Accordingly, the corresponding first configuration information varies with the manufacture process of the primary screens. The first configuration information defines a working mode and a display mode of the primary screen as the desktop. In the embodiment of the present disclosure, during initialization of a terminal device, the first configuration information of the primary screen may be acquired from the background of the terminal device.

In step S2, in response to a touch control instruction from a user, second configuration information of a virtual display layer interacting with the primary screen is determined according to the acquired first configuration information.

The primary screen of the terminal device is generally used to display the desktop. In the embodiment of the present disclosure, a virtual display layer interacting with the primary screen may be generated to prevent more desktop resources from being occupied. Specifically, an instruction for generating the virtual display layer may be issued by a user. In this case, in response to a touch control instruction from the user, the second configuration information of a virtual display layer interacting with the primary screen is determined according to the acquired first configuration information in the embodiment of the present disclosure. The second configuration information, for example, may include at least one of a location, a size, a resolution, a pixel format and a rotation angle of the virtual display layer in the primary screen.

The resolution and pixel format of the virtual display layer are generally the same as those of the primary screen, and thus a consistent visual experience is provided for the user. The location, size and rotation angle of the virtual display layer on the primary screen may be determined according to actual needs of the user. In addition, such configuration information may also be automatically generated according to the first configuration information. For example, the location of the virtual display layer on the primary screen may be predetermined at the lower right corner of the primary screen, and the size of the virtual display layer may be 30% of the size of the primary screen.

After the second configuration information is determined, the second configuration information may be called by a processor of the terminal device. As such, the terminal device may call a corresponding background program according to the second configuration information, to construct the virtual display layer on the primary screen.

It should be noted that although the virtual display layer may be displayed on the primary screen, the virtual display layer does not share the same resource with the desktop on the primary screen. The desktop of the mobile terminal may occupy the physical screen of the terminal device, whereas the virtual display layer only a virtual screen constructed by the terminal device based on the memory. Therefore, the virtual display layer does not occupy the desktop resources of the terminal device.

In step S3, the virtual display layer on the primary screen of the terminal device is generated according to the second configuration information.

After the second configuration information is determined, the terminal device may generate the virtual display layer on the primary screen thereof by calling the corresponding background program. In addition, in the embodiment of the present disclosure, the transparency of the virtual display layer may be defined. For example, assume that the transparency of the desktop on the primary screen is 0%, then the transparency of the virtual display layer may be defined to 40%. As such, when the user watches information displayed on the virtual display layer, the user is also capable of watching information displayed on the desktop on the primary screen through the virtual display layer, which enhances use experience of the user.

In step S4, video recommendation information is displayed on the virtual display layer.

After the virtual display layer is generated, the video recommendation information may be displayed on the virtual display layer. Specifically, the virtual display layer may correspond to a portion of storage space. The information displayed on the virtual display layer may be stored in the storage space, such that the virtual display layer calls the information to display the information.

Specifically, in the embodiment of the present disclosure, the video recommendation information may be pre-stored to the storage space corresponding to the virtual display layer. The video recommendation information may be a portion of video information which is determined by a video provider via analysis according to the hot degree of the video and user behaviors. After such video information is stored in the storage space as the video recommendation information, to prevent the other background programs from calling the video information, an access permission to the storage space may be configured. By such configuration, the content in the storage space may be called only by a background program which has the access permission.

Specifically, during configuring the access permission to the storage space, the background program corresponding to the virtual display layer may be added to a white list of the storage space. In other words, the background programs related to the virtual display layer may be defaulted as having the access permission to the storage space. In addition, an access password for accessing the storage space may also be configured. The access password may be stored in the background programs related to the virtual display layer. As such, when a background program related to the virtual display layer initiates an access to the storage space, it is defaulted that the background program has the access permission to the storage space, and thus is capable of normally accessing the storage space. In this way, the video recommendation information in the storage space may be displayed on the virtual display layer by accessing the storage space, for the user to check.

Accordingly, in the embodiment of the present disclosure, the configured virtual display layer is constructed by using the background program of the terminal device, which may not occupy the physical screen of the terminal device. As such, no impact is caused to the desktop resources on the primary screen.

In a preferred embodiment of the present disclosure, upon the step of displaying video recommendation information on the virtual display layer, the method further include the following step:

In step S5, an input instruction applied to the virtual display layer is detected, and a corresponding operation is performed for the virtual display layer according to a type of the input instruction.

After the virtual display layer is generated and the video recommendation information is displayed on the virtual display layer, the user may probably perform a corresponding operation for a video icon displayed on the virtual display layer. For example, the user may use a stylus pen to mark the video icon displayed on the virtual display layer, for example, circling his or her interested video icon. In addition, the user may further touch the video icon displayed on the virtual display layer directly with the fingers, to drag his or her interested video icon.

Specifically, in a preferred embodiment of the present disclosure, when the terminal device detects an input instruction on the virtual display layer, the terminal device may specifically determine the type of the input instruction. That is, the terminal device may determine whether the input instruction applied to the virtual display layer is input by means a stylus pen or a touch. To make a differentiation between the stylus pen input and the touch input, the terminal, for example, may differentiate the stylus pen input from the touch input according to a difference between a touch area of the stylus pen on the touch screen and a touch area of the fingers on the touch screen.

The terminal device may predefine a touch area threshold. When it is detected that the touch area is greater than or equal to the touch area threshold, the terminal device may consider that the type of the input instruction currently applied to the virtual display layer is touch input; and on the contrary, when it is detected that the touch area is less than the touch area threshold, the terminal device may consider that the type of the input instruction currently applied to the virtual display layer is stylus pen input.

In the embodiment of the present disclosure, the touch area corresponding to the input instruction may be detected by a method of subjecting he virtual display layer to grid portioning.

Specifically, in the embodiment of the present disclosure, the virtual display layer may be partitioned into M×N grids according to the second configuration information corresponding to the virtual display layer. In practical disclosure scenarios, to ensure the accuracy of touch area detection, each grid obtained via portioning may be defined to be smaller. As such, when it is detected that an input instruction is applied to the virtual display layer, the quantity of grids corresponding to the input instruction may be acquired. In this way, the touch area corresponding to the input instruction may be determined according to the quantity of grids.

Similarly, the terminal device may predefine a grid quantity threshold. When it is detected that the quantity of grids corresponding to an input instruction is greater than or equal to the grid quantity threshold, the terminal device may consider that the type of input instruction currently applied to the virtual display layer is touch input; and on the contrary, when it is detected that the quantity of grids corresponding to the input instruction is less than the grid quantity threshold, the terminal device may consider that the type of the input instruction currently applied to the virtual display layer is stylus input.

The terminal device may perform different operations for the virtual display layer according to different instruction types. For example, when the type of the input instruction is stylus input, the terminal device considers by default that the stylus input is an edit operation for the video icon displayed on the virtual display layer, that is, the action of circling the user's interested video icon as described above. When the type of the input instruction is touch input, the terminal device considers by default that the touch input is a move operation for the video icon displayed on the virtual display layer. For example, the move operation may be moving a video icon, and moving the video icon from a first location to a second location.

In this way, when the type of the input instruction applied to the virtual display layer is stylus pen input, the instruction input by the stylus pen may be displayed on the virtual display layer. The instruction input using a stylus pen, for example, may be a drawn circle or a mark in another shape.

In addition, when the type of the input instruction applied to the virtual display layer is touch control input, in response to the touch control input, an icon of the video recommendation on the virtual display layer may be moved.

Accordingly, with the video recommendation method according to the embodiment of the present disclosure, a primary screen of a terminal device is analyzed, and after first configuration information of the primary screen of the terminal device is determined, second configuration information of a virtual display layer interacting with the primary screen may be generated according to the first configuration information. The virtual display layer is not a physical display layer of the terminal device, which may not excessively occupy resources on the desktop of the terminal. The video recommendation information is displayed on the virtual display layer. This not only provides the video recommendation information for a user, but also prevents resources on the desktop of the terminal device from being occupied. In this way, the user is capable of normally using the desktop of the terminal device while browsing the video recommendation information, which greatly improves user's operation experience.

Specifically, according to the specific embodiments of the present disclosure, input instructions on the virtual display layer are analyzed, such that different response operations may be performed for different input instructions. In this way, convenience and smartness of the operations of the virtual display layer are ensured, and user's normal usage requirements are satisfied.

An embodiment of the present disclosure further provides an apparatus for implementing video recommendation. FIG. 2 is a schematic structural diagram illustrating an apparatus for implementing video recommendation in terms of functional modules according to an embodiment of the present disclosure.

As illustrated in FIG. 2, the apparatus may include:

a first configuration information acquiring module 100, configured to acquire first configuration information of a primary screen of a terminal device;

a second configuration information determining module 200, configured to, determine in response to a touch control instruction from a user, according to the acquired first configuration information, second configuration information of a virtual display layer interacting with the primary screen;

a virtual display layer generating module 300, configured to generate the virtual display layer on the primary screen of the terminal device according to the second configuration information; and

a video recommendation information displaying module 400, configured to display video recommendation information on the virtual display layer.

The first configuration information of the primary screen of the terminal device includes at least one of a width, a height, a pixel format, a color depth, a spacing and a memory address of the primary screen,

The second configuration information includes at least one of a location, a size, a resolution, a pixel format and a rotation angle of the virtual display layer in the primary screen.

In a preferred embodiment of the present disclosure, in addition to the video recommendation displaying module 400, the apparatus may further include:

an operating module 500, configured to detect an input instruction applied to the virtual display layer, and perform a corresponding operation for the virtual display layer according to a type of the input instruction.

The operating module 500 may include:

a first operating module, configured to, when the type of the input instruction applied to the virtual display layer is stylus pen input, display the instruction input by the stylus pen on the virtual display layer; and/or a second operating module, configured to, when the type of the input instruction applied to the virtual display layer is touch control input, in response to the touch control input, move an icon of the video recommendation in the virtual display layer.

In another preferred embodiment of the present disclosure, the video recommendation displaying module 400 specifically includes:

a pre-storing module, configured to pre-store the video recommendation information to a storage space corresponding to the virtual display layer;

an access permission acquiring module, configured to acquire an access permission to the storage space; and

a displaying module, configured to display the video recommendation information in the storage space on the virtual display layer by accessing the storage space.

It should be noted that, implementations of various functional modules in the above embodiment are consistent with the descriptions in steps S1 to S3, which are thus not described herein any further.

Accordingly, with the apparatus for implementing video recommendation according to the embodiment of the present disclosure, a primary screen of a terminal device is analyzed, and after first configuration information of the primary screen of the terminal device is determined, second configuration information of a virtual display layer interacting with the primary screen may be generated according to the first configuration information. The virtual display layer is not a physical display layer of the terminal device, which may not excessively occupy resources on the desktop of the terminal. The video recommendation information is displayed on the virtual display layer. This not only provides the video recommendation information for a user, but also prevents resources on the desktop of the terminal device from being occupied. In this way, the user is capable of normally using the desktop of the terminal device while browsing the video recommendation information, which greatly improves user's operation experience.

Specifically, according to the embodiments of the present disclosure, input instructions on the virtual display layer are analyzed, such that different response operations may be performed for different input instructions. In this way, convenience and smartness of the operations of the virtual display layer are ensured, and user's normal usage requirements are satisfied.

Embodiments of the present disclosure further provide a non-volatile computer-readable storage medium, the non-volatile computer-readable storage medium is stored with computer executable instructions which are configured to perform any of the embodiments described above of the method for implementing video recommendation.

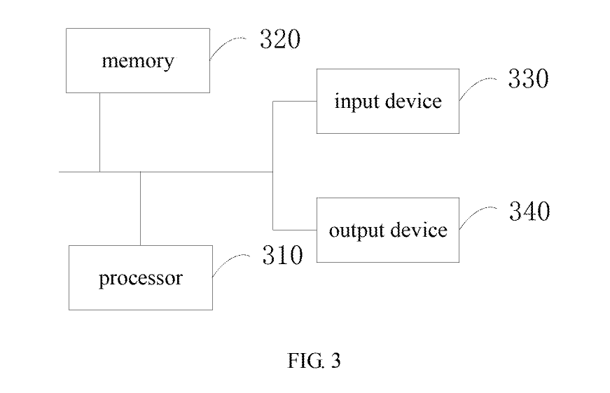

FIG. 3 is a schematic structural diagram illustrating an electronic device according to the present disclosure, as shown in FIG. 3, the device includes:

One or more processors 310 and a memory 320, FIG. 3 illustrates one processor 310 as an example.

The device for the method for implementing video recommendation may further include an input device 330 and an output device 340.

The processor 310, the memory 320, the input device 330 and the output device 340 may be connected with each other through bus or other forms of connections. FIG. 3 illustrates bus connection as an example.

As a non-volatile computer-readable storage medium, the memory 320 may be configured to store non-volatile software program, non-volatile computer executable program and modules, such as program instructions/modules corresponding to the method for implementing video recommendation according to the embodiments of the disclosure (for example, the first configuration information acquiring module 100, the second configuration information determining module 200, the virtual display layer generating module 300, the video recommendation info nation displaying module 400 and the operating module 500, as illustrated in FIG. 2). By executing the non-volatile software program, instructions and modules stored in the memory 320, the processor 310 may perform various functional applications of the server and data processing, that is, the method for implementing video recommendation according to the above mentioned embodiments.

The memory 320 may include a program storage area and a data storage area, wherein, the program storage area may be stored with the operating system and applications which are needed by at least one functions, and the data storage area may be stored with data which is created according to use of the device for implementing video recommendation. Further, the memory 320 may include a high-speed random access memory, and may further include non-volatile memory, such as at least one of disk memory device, flash memory device or other types of non-volatile solid state memory device. In some embodiments, optionally, the memory 320 may include memory provided remotely from the processor 310, and such remote memory may be connected with the device for implementing video recommendation through network connections, the examples of the network connections may include but not limited to internet, intranet, LAN (Local Area Network), mobile communication network or combinations thereof.

The input device 330 may receive inputted number or character information, and generate key signal input related to the user settings and functional control of the device for implementing video recommendation. The output device 340 may include a display device such as a display screen.

The above one or more modules may be stored in the memory 320, when these modules are executed by the one or more processors 310, the method for implementing video recommendation according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof Such modifications and substitutions do not cause the corresponding technical features to depart in substance from the spirit and scope of the technical solutions of various embodiments of the present disclosure.

What is claimed is:

1. A method for implementing video recommendation, comprising: at an electronic device:
acquiring first configuration information of a primary screen of a terminal device;
determining in response to a touch control instruction from a user, according to the acquired first configuration information, second configuration information of a virtual display layer interacting with the primary screen;
generating the virtual display layer on the primary screen of the terminal device according to the second configuration information; and
displaying video recommendation information on the virtual display layer.

2. The method for implementing video recommendation according to claim 1, wherein the first configuration information of the primary screen of the terminal device comprises at least one of a width, a height, a pixel format, a color depth, a spacing and a memory address of the primary screen.

3. The method for implementing video recommendation according to claim 1, wherein the second configuration information comprises at least one of a location, a size, a resolution, a pixel format and a rotation angle of the virtual display layer in the primary screen.

4. The method for implementing video recommendation according to claim 1, wherein the displaying video recommendation information on the virtual display layer comprises:
pre-storing the video recommendation information to a storage space corresponding to the virtual display layer;
acquiring an access permission to the storage space; and
displaying the video recommendation information in the storage space on the virtual display layer by accessing the storage space.

5. The method for implementing video recommendation according to claim 1, wherein upon the step of displaying video recommendation information on the virtual display layer, the method further comprises:
detecting an input instruction applied to the virtual display layer, and performing a corresponding operation for the virtual display layer according to a type of the input instruction.

6. The method for implementing video recommendation according to claim 5, wherein the detecting an input instruction applied to the virtual display layer, and performing a corresponding operation for the virtual display layer according to a type of the input instruction comprises:
when the type of the input instruction applied to the virtual display layer is stylus pen input, displaying the instruction input by the stylus pen on the virtual display layer.

7. The method for implementing video recommendation according to claim 5, wherein the detecting an input instruction applied to the virtual display layer, and performing a corresponding operation for the virtual display layer according to a type of the input instruction comprises:
when the type of the input instruction applied to the virtual display layer is touch control input, in response to the touch control input, moving an icon of the video recommendation in the virtual display layer.

8. An electronic device, comprising:
at least one processor; and
a memory communicably connected with the at least one processor for storing instructions executable by the at least one processor, wherein execution of the instructions by the at least one processor causes the at least one processor to:
acquire first configuration information of a primary screen of a terminal device;
determine in response to a touch control instruction from a user, according to the acquired first configuration information, second configuration information of a virtual display layer interacting with the primary screen;
generate the virtual display layer on the primary screen of the terminal device according to the second configuration information; and
display video recommendation information on the virtual display layer.

9. The electronic device according to claim 8, wherein the step to display video recommendation information on the virtual display layer comprises:
pre-storing the video recommendation information to a storage space corresponding to the virtual display layer;
acquiring an access permission to the storage space; and
displaying the video recommendation information in the storage space on the virtual display layer by accessing the storage space.

10. The electronic device according to claim 8, the at least one processor is further caused to:
detect an input instruction applied to the virtual display layer, and perform a corresponding operation for the virtual display layer according to a type of the input instruction.

11. A non-transitory computer-readable storage medium storing executable instructions that, when executed by an electronic device with a touch-sensitive display, cause the electronic device to:
acquire first configuration information of a primary screen of a terminal device;
determine in response to a touch control instruction from a user, according to the acquired first configuration information, second configuration information of a virtual display layer interacting with the primary screen;
generate the virtual display layer on the primary screen of the terminal device according to the second configuration information; and
display video recommendation information on the virtual display layer.
